(19) United States
(12) Patent Application Publication
(10) Pub. No.: US 2014/0002374 A1
(43) Pub. Date: Jan. 2, 2014

(54) TEXT SELECTION UTILIZING PRESSURE-SENSITIVE TOUCH

(71) Applicants: John Miles Hunt, Raleigh, NC (US); John Weldon Nicholson, Cary, NC (US); James Stephen Rutledge, Durham, NC (US); Song Wang, Cary, NC (US)

(72) Inventors: John Miles Hunt, Raleigh, NC (US); John Weldon Nicholson, Cary, NC (US); James Stephen Rutledge, Durham, NC (US); Song Wang, Cary, NC (US)

(73) Assignee: LENOVO (SINGAPORE) PTE. LTD., Singapore (SG)

(21) Appl. No.: 13/537,558

(22) Filed: Jun. 29, 2012

(51) Int. Cl. G06F 3/041

(52) U.S. Cl. 345/173

(57) ABSTRACT

An aspect provides a method, including: accepting touch input exceeding a touch detection threshold at a touch sensitive surface of a device; displaying content on a touch screen display of the device; and selecting text of the content displayed on the touch screen display while detecting a pressure input which exceeds a pressure threshold greater than the touch detection threshold. Other aspects are described and claimed.

### BACKGROUND

Text selection on touch screen display devices is accomplished via interfacing with the device using two dimensions, namely touch location and timing. Thus, a long press (time dimension) at a location within the touch screen display (location dimension) is utilized to ascertain that a user wishes to select text or perform some other function on the touch screen other than scrolling or zooming.

Once the user provides the long press, for example a touch and hold on the order of seconds, text (usually of a word or a part thereof) may thereafter be highlighted or otherwise indicated for an action, such as a copy action or a cut action. A user may reorient the highlighting to perfect the selection of which text is to be copied, cut, et cetera. Once the user finalizes the text selection, the user is offered a selection of functions to perform on the selected text, for example performing a copy action.

### BRIEF SUMMARY

In summary, one aspect provides a method, comprising: accepting touch input exceeding a touch detection threshold at a touch sensitive surface of a device; displaying content on a touch screen display of the device; and selecting text of the content displayed on the touch screen display while detecting a pressure input which exceeds a pressure threshold greater than said touch detection threshold.

Another aspect provides an information handling device, comprising: a touch sensitive surface; a touch screen display; one or more processors; and a memory in operative connection with the one or more processors that stores instructions executable by the one or more processors to perform acts comprising: accepting touch input exceeding a touch detection threshold at the touch sensitive surface of the information handling device; displaying content on the touch screen display of the information handling device; and selecting text of the content displayed on the touch screen display while detecting a pressure input which exceeds a pressure threshold greater than said touch detection threshold.

A further aspect provides a program product, comprising: a storage medium having program code embodied therewith, the program code comprising: program code configured to accept touch input exceeding a touch detection threshold at the touch sensitive surface of the information handling device; program code configured to display content on the touch screen display of the information handling device; and program code configured to select text of the content displayed on the touch screen display while detecting a pressure input which exceeds a pressure threshold greater than said touch detection threshold.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example information handling device.

FIG. 2 illustrates another example information handling device.

FIG. 3 illustrates a side view of an example information handling device.

FIG. 4 illustrates an example method of using pressure inputs in combination with a touch screen display.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Pressure-sensitive multi-touch surfaces include pressure sensors and thus provide additional mechanisms of input, over and above touch based sensing surfaces, adding another dimension to the existing methods, namely, pressure-based input. Utilizing these pressure sensors, new and intuitive controls are enabled.

Conventionally, text manipulation on touch screen devices (also referred to herein as touch screen displays or touch screen systems) remains problematic even in the face of numerous innovations and improvements to touch-based user interfaces. Such displays are frequently imprecise, for example due to the dexterity required, and the gesture complexity necessary to avoid overlapping with more common gestures. Thus, a user may intend to provide one input, while actually executing another.

Most touch screen text selection systems work by initiating text selection with a long press on a certain area of the screen. The user is then presented with a highlighted region encompassing the selected piece of text (for example a word, or perhaps some kind of application or OS specific region), and a set of handles to adjust the extent of that region for positioning or selecting the text. The user may then be presented with a menu of actions to be taken on the selected region (copy, paste, et cetera) either after each adjustment of the selection, or by a final tap of the selection.

There are a few drawbacks to this approach. For example, since the selection frequently has to-the-letter resolution, the act of removing a finger from one of the selection handles can frequently move it by a letter or two. This can lead to a frustrating cycle of the user repositioning the selection along with an increasingly careful finger removal. As another example, accurate text selection often requires zooming in from a comfortable reading level of zoom, especially on many devices having a compact screen, such as tablet and smart phone implementations. This can disrupt a user's thought process and require them to zoom back out before continuing.

Accordingly, an embodiment provides additional capabilities for touch-based input to an information handling device such as for example a laptop, a tablet or a smart phone. An embodiment provides an additional pressure-based mechanism wherein pressure sensors are associated with a touch-based surface, for example a pressure sensitive touch pad, to provide a user with mechanisms for providing pressure-based input. For example, due to the pressure-sensitivity, text selection can be triggered by a certain amount of pressure. This removes overlap with more general-purpose touch screen gestures, making a long press unnecessary. Text may be selected by sliding fingers, for example under pressure, and the selection can be finalized by releasing the pressure, even if the user has not released the touch (contact). Because the finger no longer has to move, one off selection errors are minimized. Releasing the touch may in turn trigger a copy or cut as well; removing or modifying one more step from the touch based input process.

An embodiment may facilitate zooming. For example, the act of applying pressure to initiate the text selection process may also zoom in on the text being selected. Thus for example, as the pressure is increased, as sensed through pressure sensors associated with the touch sensitive surface, so is the zoom, centered on that region of display. Since the finger position may still change when pressure is applied, the text selection can still be fine-tuned. In other words, the touch sensitive surfaces and pressure sensors associated therewith continues to provide a means for more conventional touch based input via location sensing. When the pressure is released, the text may be captured and the zoom may be returned to the previous, comfortable reading level.

An embodiment may provide multiple touch sensitive surfaces, for example a touch sensitive surface having pressure sensitive surfaces associated therewith and a touch screen display. An embodiment may provide a touch sensitive surface having pressure sensors associated therewith on a first side of the device, and a touch screen display on a second side of the device. An embodiment may provide the touch sensitive surface having pressure sensors associated therewith on a back side of the device, opposite a touch screen display positioned on a front side of the device.

Accordingly, an embodiment may permit a user to provide touch based input, along with pressure based input, via the touch sensitive surface having pressure sensors associated therewith on the back of the device, for manipulating (for example, selecting, copying, cutting) text displayed on the touch screen display on the front side of the device. Such an arrangement provides an additional input device that may be used in conjunction with a touch screen display. Moreover, by positioning the touch sensitive surface having pressure sensing capabilities on a back side (opposite side) with respect to the touch screen display, the user is free to provide pressure sensitive inputs and location or time sensitive inputs via the back of the device while viewing the resultant actions (for example, text selection or zooming action) on the front of the device.

The illustrated example embodiments will be best understood by reference to the figures. The following description is intended only by way of example, and simply illustrates certain example embodiments.

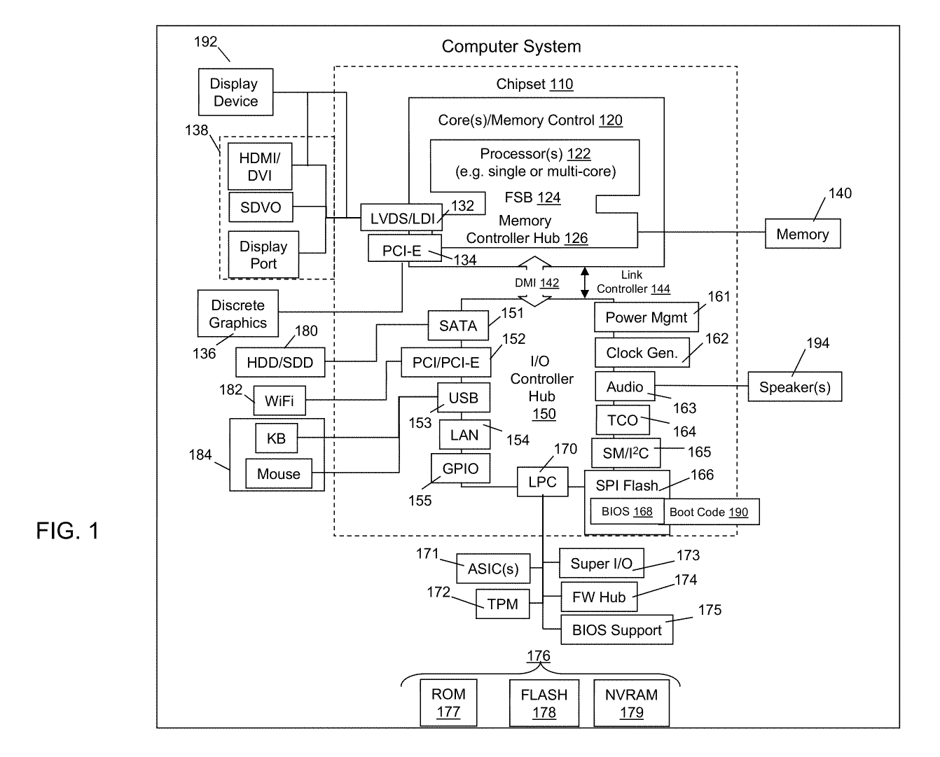

While various other circuits, circuitry or components may be utilized, FIG. 1 depicts a block diagram of one example of information handling device circuits, circuitry or components. The example depicted in FIG. 1 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 1.

The example of FIG. 1 includes a so-called chipset 110 (a group of integrated circuits, or chips, that work together, chipsets) with an architecture that may vary depending on manufacturer (for example, INTEL, AMD, ARM, etc.). The architecture of the chipset 110 includes a core and memory control group 120 and an I/O controller hub 150 that exchanges information (for example, data, signals, commands, et cetera) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that supplants the conventional “northbridge” style architecture.

In FIG. 1, the memory controller hub 126 interfaces with memory 140 (for example, to provide support for a type of RAM that may be referred to as “system memory” or “memory”). The memory controller hub 126 further includes a LVDS interface 132 for a display device 192 (for example, a CRT, a flat panel, touch screen, et cetera). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 1, the I/O hub controller 150 includes a SATA interface 151 (for example, for HDDs, SDDs, 180 et cetera), a PCI-E interface 152 (for example, for wireless connections 182), a USB interface 153 (for example, for devices 184 such as a digitizer, keyboard, mice, cameras, phones, storage, other connected devices, et cetera), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (for example, for speakers 194), a TCO interface 164, a system management bus interface 165, and SPI Flash 166, which can include BIOS 168 and boot code 190. The I/O hub controller 150 may include gigabit Ethernet support.

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations and accessed, for example, according to instructions of the BIOS 168. As described herein, a device may include fewer or more features than shown in the system of FIG. 1.

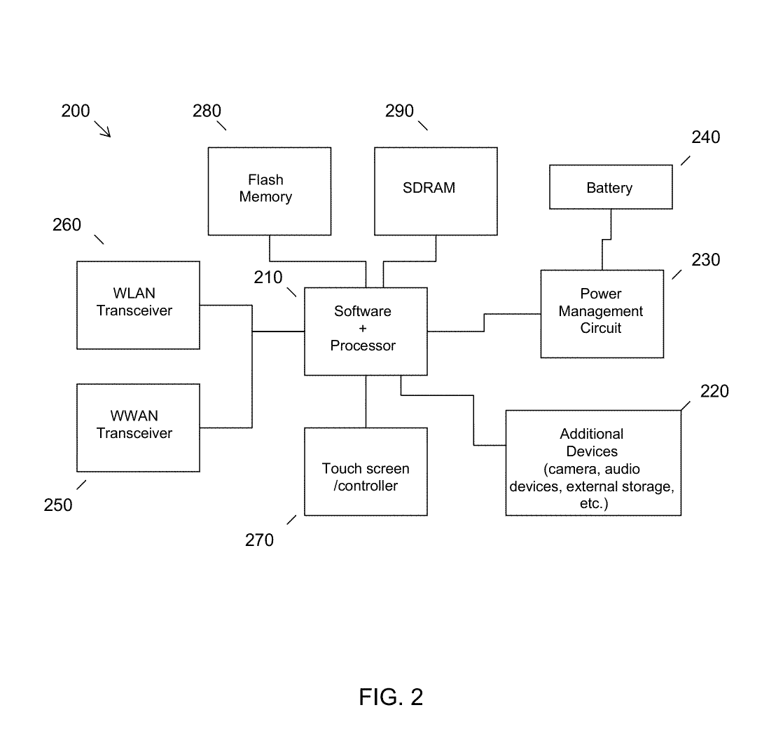

For example, referring to FIG. 2, with regard to smart phone and/or tablet circuitry 200, an example includes an ARM based system (system on a chip) design, with software and processor(s) combined in a single chip 210. Internal busses and the like depend on different vendors, but essentially all the peripheral devices (220) may attach to a single chip 210. In contrast to the circuitry illustrated in FIG. 1, the tablet circuitry 200 combines the processor, memory control, and I/O controller hub all into a single chip 210. Also, ARM based systems 200 do not typically use SATA or PCI or LPC. Common interfaces for example include SDIO and I2C. There are power management chip(s) 230, which manage power as supplied for example via a rechargeable battery 240, which may be recharged by a connection to a power source (not shown), and in at least one design, a single chip, such as 210, is used to supply BIOS like functionality and DRAM memory.

ARM based systems 200 typically include one or more of a WWAN transceiver 250 and a WLAN transceiver 260 for connecting to various networks, such as telecommunications networks and wireless base stations. Commonly, an ARM based system 200 will include a touch screen 270 for data input and display. ARM based systems 200 also typically include various memory devices, for example flash memory 280 and SDRAM 290.

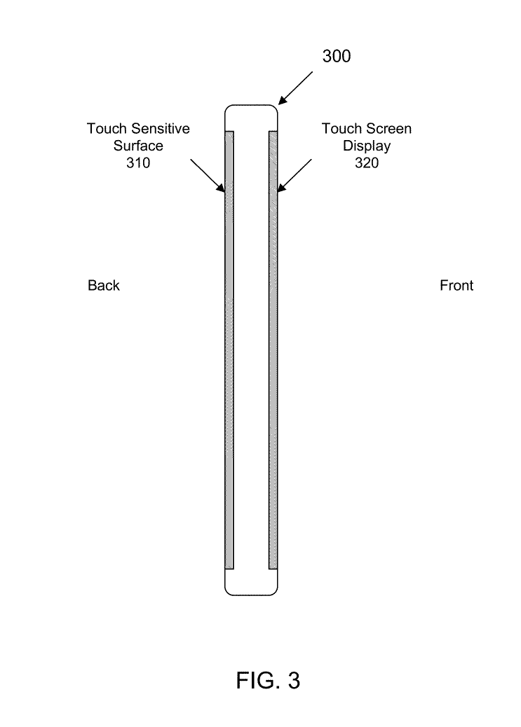

Referring to FIG. 3, an example device having additional touch based input capabilities as described herein is illustrated in a side view. The device 300, such as a tablet computer, is provided with a touch sensitive surface having pressure sensor(s) associated therewith (hereinafter simply “touch sensitive surface”) 310. The device 300 is also provided with a touch screen display 320.

The touch sensitive surface 310, for its part, provides touch based input sensing mechanisms, for example location based sensing, time based sensing and pressure based sensing, or a suitable combination of the foregoing, as will be apparent given the functionality described in connection with the various examples given herein. Thus, a user may provide location and pressure sensing input for selecting text displayed on the touch screen display 320.

The touch screen display 320, for its part, may provide for location and time based sensing, for example allowing a user to scroll or otherwise reposition or resize a web page or document displayed thereon, as well as providing time based input such as a long press input, if desired. It should be noted that although the touch sensitive surface 310 and the touch screen display 320 are illustrated as being approximately equal in size, this is not a requirement.

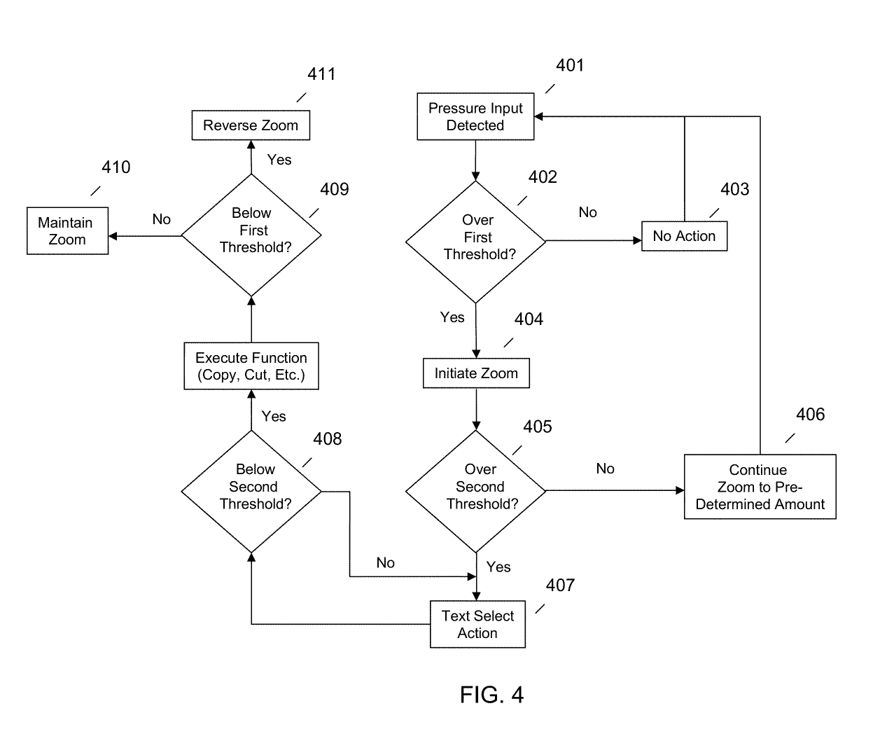

The device 300 may provide for utilizing inputs from the touch screen display 320, the touch sensitive surface 310, or both. Alternatively, either the touch sensitive surface 310 or the touch screen display 320 may be used in isolation. An embodiment provides for coordinated use of both the touch sensitive surface 310 and the touch screen display 320, as for example described in connection with FIG. 4.

In FIG. 4, an example method of coordinated use of both the touch sensitive surface 320 and the touch screen display 320 is illustrated. As an example, a zoom and copy action using two pressure thresholds will be described. It should be noted however, that the precise steps described in the example may be performed in a different order, and other steps (more steps or fewer steps) may be provided to accomplish the same actions or different actions than those given in this specific, non-limiting example.

An embodiment ascertains pressure input via the touch sensitive surface at 401. As the user provides pressure over a first threshold pressure at 402, an embodiment may initiate a zoom action of the text displayed on the touch screen display at 404. If the use only applies minimal, sub-threshold pressure, an embodiment may take no action. The zoom action may continue to take place to a predetermined amount, for example a maximum zoom at 406, if no further pressure is detected at 405 (that is, the pressure does not exceed the second threshold).

However, if the user presses harder on the touch sensitive surface and exceeds a second threshold pressure at 405, an embodiment may initiate a text selection action at 407, for example highlighting the text on the display screen appearing between a user's fingers, as ascertained via the touch sensitive surface on the back of the device. The text selection action may include various phases, such as an initial highlighting phase, followed by the display of handles (displayed on the touch screen display) that the user may use to modify the initially selected text region. Once the user has selected the desired text, the user may begin to release the pressure on the touch sensitive device, passing the second threshold pressure at 408 in the reverse fashion (releasing pressure).

If the user's pressure input is not released below the second threshold at 408, the text selection may remain active. However, if at 408 the user crosses the second pressure threshold in reverse, functionality may be executed at 409, in this example, a copy action. If the user continues to release pressure through the first threshold at 409, the zoom may be reversed in a predetermined way such that the original or a default zoom level is regained on the touch screen display at 411. If the user maintains the pressure between the first and second threshold, the zoom may be maintained until the user releases the pressure 410.

In another example embodiment, pressure input (for example, exceeding a “zooming threshold” over and above an initial, touch input indicative of a user simply touching the touch sensitive surface—“touch detection threshold”) is ascertained and initiates a zooming function. Text selection (X,Y positioning) on the touch sensitive surface moves the selection carets to highlight or otherwise select the text displayed on the touch screen display device. As the user stops applying pressure or releases pressure, an embodiment zooms back out. An embodiment may lock the selection during this release action such that the selection carets do not move. Thus, an embodiment may supply some temporal hysteresis that prevents the selection carets from moving as the user is letting go or releasing pressure. Thus, as the user releases pressure below some pressure threshold (a threshold that is over and above simple touch based pressure indicative of the user simply touching the touch sensitive surface), text selection may be locked in. An appropriate action on the selected text (copy, cut, et cetera) may be provided by soft buttons, provided automatically by default, or via any other suitable means.

Accordingly, embodiments provide text selection functionality that is combined with zooming via employment of one or more pressure inputs in a suitable combination. Thus, a text selection or other functionality may be triggered by a certain amount of pressure. While the above examples use specific pressure thresholds, any number of pressure thresholds may be implemented to achieve various alternate or modified functionality. Among other features, an embodiment removes overlap with more general-purpose touchscreen gestures, making a long press unnecessary. Text may be selected by sliding fingers, for example under pressure, and the selection can be finalized by releasing the pressure, even if the user has not released the touch (contact) with the touch sensitive surface. Because the finger no longer has to move, one off selection errors are minimized. As described herein, releasing the touch may in turn trigger functionality, such as a copy or cut, removing or modifying one more step from the touch based input process.

An embodiment may also resolve zooming issues associated with conventional touch screen displays. For example, the act of applying pressure to initiate the text selection process may also zoom in on the text being selected. Thus for example, as the pressure is increased, as sensed through pressure sensors associated with the touch sensitive surface, so is the zoom. Since the finger position may still change when pressure is applied, the text selection can still be fine-tuned without obstructing the user's view of the touch screen display (no fingers need be placed on the touch screen display for text selection). In other words, the touch sensitive surfaces and pressure sensors associated therewith continues to provide a means for more conventional touch based input via location sensing. When the pressure is released, the text may be captured and the zoom may be returned to the previous, comfortable reading level.

Embodiments may be implemented in one or more information handling devices configured appropriately to execute program instructions consistent with the functionality of the embodiments as described herein. In this regard, FIG. 1, FIG. 2 and FIG. 3 illustrate non-limiting examples of such devices and components thereof. While mobile computing systems such as tablet computers, laptop computers, and smart phones have been specifically mentioned as examples herein, embodiments may be implemented using other systems or devices, such as e-readers, navigation systems, kiosks, and the like.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality illustrated may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified.

The program instructions may also be loaded onto a device to cause a series of operational steps to be performed on the device to produce a device implemented process such that the instructions which execute on the device provide processes for implementing the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
accepting touch input exceeding a touch detection threshold at a touch sensitive surface of a device;
displaying content on a touch screen display of the device; and
selecting text of the content displayed on the touch screen display while detecting a pressure input which exceeds a pressure threshold greater than said touch detection threshold.

2. The method of claim 1, wherein the touch sensitive surface is disposed on a first side of the device; and further wherein the touch screen display is disposed on a side of the device substantially opposite to the touch sensitive surface.

3. The method of claim 2, further comprising: ascertaining pressure input exceeding a zooming threshold at the touch sensitive surface.

4. The method of claim 3, wherein responsive to ascertaining pressure input exceeding the zooming threshold, a zoom function is performed to magnify the content displayed on the touch screen.

5. The method of claim 3, further comprising: responsive to ascertaining pressure input exceeding the zooming threshold, selecting text of the content displayed on the touch screen display.

6. The method of claim 5, further comprising:
responsive to selecting text of the content displayed on the touch screen display, accepting input refining text selection.

7. The method of claim 6, wherein the input refining text selection is ascertained utilizing the touch sensitive surface.

8. The method of claim 7, further comprising, responsive to refining text selection, performing a reverse zoom function responsive to ascertaining pressure release through the pressure threshold.

9. The method of claim 8, further comprising: responsive to selecting text of the content displayed on the touch screen display, performing one or more of a copy action and a cut action.

10. The method of claim 1, further comprising responsive to selecting text of the content displayed on the touch screen display, locking the text selection in response to detecting decreased pressure input.

11. An information handling device, comprising:
a touch sensitive surface;
a touch screen display;
one or more processors; and
a memory in operative connection with the one or more processors that stores instructions executable by the one or more processors to perform acts comprising:
accepting touch input exceeding a touch detection threshold at the touch sensitive surface of the information handling device;
displaying content on the touch screen display of the information handling device; and
selecting text of the content displayed on the touch screen display while detecting a pressure input which exceeds a pressure threshold greater than said touch detection threshold.

12. The information handling device of claim 11, wherein the touch sensitive surface is disposed on a first side of the information handling device; and further wherein the touch screen display is disposed on a side of the information handling device substantially opposite to the touch sensitive surface.

13. The information handling device of claim 12, wherein to perform acts further comprises ascertaining pressure input exceeding a zooming threshold at the touch sensitive surface.

14. The information handling device of claim 13, wherein responsive to ascertaining pressure input exceeding the zooming threshold, a zoom function is performed to magnify the content displayed on the touch screen.

15. The information handling device of claim 13, wherein to perform acts further comprises responsive to ascertaining pressure input exceeding the zooming threshold, selecting text of the content displayed on the touch screen display.

16. The information handling device of claim 15, wherein to perform acts further comprises responsive to selecting text of the content displayed on the touch screen display, accepting input refining text selection.

17. The information handling device of claim 16, wherein the input refining text selection is ascertained utilizing the touch sensitive surface.

18. The information handling device of claim 17, wherein to perform acts further comprises responsive to refining text selection, performing a reverse zoom function responsive to ascertaining pressure release through the pressure threshold.

19. The information handling device of claim 18, wherein to perform acts further comprises responsive to selecting text of the content displayed on the touch screen display, performing one or more of a copy action and a cut action.

20. A program product, comprising:
a storage medium having program code embodied therewith, the program code comprising:
program code configured to accept touch input exceeding a touch detection threshold at the touch sensitive surface of the information handling device;
program code configured to display content on the touch screen display of the information handling device; and
program code configured to select text of the content displayed on the touch screen display while detecting a pressure input which exceeds a pressure threshold greater than said touch detection threshold.
